(19) United States
(12) Patent Application Publication
(10) Pub. No.: US 2018/0372168 A1
(43) Pub. Date: Dec. 27, 2018

(54) CLUTCH ASSEMBLY WITH CLUTH RAMP

(71) Applicant: GKN Automotive Ltd., Redditch, Worcestershire (GB)

(72) Inventor: Wolfgang Manfred Beigang, Neunkirchen-Seelscheid (DE)

(21) Appl. No.: 16/069,564

(22) PCT Filed: Jan. 19, 2016
(86) PCT No.: PCT/EP2016/050999

§ 371 Date: Jul. 12, 2018

(51) Int. Cl. F16D 23/12; F16D 11/14; F16D 28/00

(52) U.S. Cl. CPC F16D 23/12; F16D 11/14; F16D 2121/24; F16D 2023/123; F16D 28/00

(57) ABSTRACT

The invention relates to a clutch assembly for a motor vehicle, comprising: a disconnect clutch for disconnecting a driveline; a spring element which loads the disconnect clutch into a closed position; a ball ramp unit for loading the disconnect clutch into an open position, wherein the ball ramp unit comprises an outer ring with outer ball tracks, an inner ring with inner ball tracks and a plurality of balls; a drive unit for operating the ball ramp unit; wherein the outer and inner ball tracks are configured to be ramp-like such that a rotation of one of the rings effected by the drive unit results in an axial movement between the rings so that the disconnect clutch is opened; wherein the outer and inner ball tracks extend in the circumferential direction across less than 120° and wherein the outer and inner ball tracks are configured such that a force line, that in a longitudinal section extends through an outer and inner ball contact area, encloses an angle with the rotational axis which is greater than 0° and smaller than 90°.

### CROSS-REFERENCE TO RELATED APPLICATIONS

This application is a national stage of, and claims priority to, Patent Cooperation Treaty Application No. PCT/EP2016/050999, filed on Jan. 19, 2016, which application is hereby incorporated herein by reference in its entirety.

### BACKGROUND

The following drive concepts for a vehicle can be differentiated. In a motor vehicle with a front engine the front axle is permanently driven and the rear axle is optionally drivingly connectable. Furthermore, there are motor vehicles with a front engine in which the rear axle is permanently driven and the front axle is optionally drivingly connectable. Finally, there are motor vehicles with a rear engine in which the rear axle is permanently driven, with the front axle being optionally connected by a hang-on clutch.

From WO 2015 120909 A1 a clutch assembly for the driveline of a motor vehicle is known. The clutch assembly comprises a clutch which can drivingly connect or disconnect a first shaft and a second shaft; a brake by which the second shaft can be braked relative to a stationary component, and an operating device by which the clutch and the brake can be operated such that the brake is not operated until the clutch is at least partially opened. The operating device comprises an electric motor and a ramp assembly.

DE 10 2005 007 651 A1 proposes a transfer case having a controllable clutch device for a motor vehicle with a switchable four wheel drive. The clutch assembly can be operated via an electric motor and a drive convertor. The drive convertor comprises a spindle nut assembly which converts a rotational movement of the electric motor into a translatory movement for operating the clutch device. The electric motor is configured as an asynchronous motor.

From DE 203 14 141 U1 an axial setting device is known for operating a multi-plate clutch in the driveline of a motor vehicle. The axial adjusting device comprises a ball ramp assembly having a supporting disc which is fixed in the housing in axial, radial and rotationally fixed way, and a setting disc that is axially moveable thereto and that is rotatingly drivable by an electric motor. The supporting disc and the setting disc comprise circumferentially distributed ball grooves with variable depths between each of which a ball is received. The setting disc is axially supported against the multi-plate clutch and is axially and radially supported by the balls held in the ball grooves.

### SUMMARY

A clutch assembly for a motor vehicle includes a plurality of driving axles. In particular, the clutch assembly can be used for a driveline assembly which comprises a first driveline for permanently driving a first driving axle, as well as a second driveline for optionally driving a second driving axle. Such drive concepts having an optionally connectable and disconnectable driving axle are also referred to as a “hang-on,” “on-demand,” or “disconnect” system.

The disclosed clutch assembly with a ball ramp unit comprises a compact configuration, allows secure switching of an optionally drivable driveshaft, and can be operated efficiently, with the energy demand for operating and holding a switched position being preferably low. Further disclosed is an efficient method of controlling such a clutch assembly. Further disclosed is a driveline assembly including such a clutch assembly which permits a driveline portion to be stopped.

A clutch assembly for a driveline of a motor vehicle comprises a disconnect clutch for disconnecting a driveline, wherein the disconnect clutch comprises at least a first clutch part and a second clutch part; a spring element which loads the disconnect clutch into a closed position in which torque is transmittable between the first clutch part and the second clutch part; a ball ramp unit for loading the disconnect clutch into an open position, wherein the ball ramp unit comprises an outer ring with a plurality of circumferentially distributed outer ball tracks, an inner ring with a plurality of circumferentially distributed inner ball tracks and a plurality of balls which are each arranged between an outer ball track and an inner ball track; a drive unit for operating the ball ramp unit, wherein the drive unit is configured to rotatingly drive one of the outer ring and the inner ring around a rotational axis; wherein the outer ball tracks and the inner ball tracks are configured to be ramp-like such that by rotatingly driving the rotatingly drivable ring by the drive unit, there is effected a relative axial movement between the outer ring and the inner ring, so that the disconnect clutch is opened; wherein the outer ball tracks and the inner ball tracks extend in the circumferential direction across less than 120°, and wherein the outer ball tracks and the inner ball tracks are configured such that a force line extending in a longitudinal section through an outer and an inner ball contact point enclose an angle with the rotational axis that is greater than 0° and smaller than 90°.

An advantage of the ball ramp unit is that the outer ring and the inner ring are supported relative to one another via the balls, both in the axial and in the radial direction. This means that the balls transmit both axial forces from the axially supported ring to the axially movable ring when the drive unit is operated, as well as radial forces which are effective between the two rings, in particular when the drive unit is operated. Because the lines of force extending through the ball contact areas respectively enclose an acute angle with the rotational axis, if viewed in a longitudinal section, an angular contact bearing type assembly is achieved. This results in particularly effective radial supporting conditions for the outer ring relative to the inner ring. Together with the axial gradient of the ball tracks a double function of the ball ramp unit is thus achieved, i.e., a function of a rotation translation converter and of a radial bearing.

According to an embodiment, the outer ball tracks and the inner ball tracks are arranged so as to at least partially axially overlap. In particular it is proposed that the outer ball tracks comprise a greater mean diameter than the inner ball tracks. In this way, the inner ring is able to axially extend into the outer ring, wherein the radially opposed outer ring ball tracks and inner ring ball tracks at least partially axially overlap. According to an embodiment it is proposed that a smallest inner diameter of the outer ring ball tracks is greater than a greatest outer diameter of the inner ring ball tracks. Accordingly, it is possible that the outer ring comprises a greater diameter than the inner ring. At least one of the two rings can be sleeve-shaped. The axial length of the outer ring and of the inner ring depends in the travel requirements of the clutch and can be in particular smaller than three times, preferably smaller than twice the ball diameter of the balls. In this way an axially compact design is achieved.

An outer ring supporting face and an inner ring supporting face form a respective pair of tracks or a pair of supporting faces, in each of which a ball is guided, wherein the ball tracks of the outer ring and of the inner ring are axially and radially supported relative to one another. A ball contact point means an area at which a ball is in surface contact with the outer and, respectively, with the inner supporting face. To the extent that a contact area is linear if viewed in a longitudinal section, for instance because the ball is in contact with the respective supporting face across a circumferential segment of the ball, the ball contact point in the longitudinal section refers to a central contact area of the contact area.

When rolling along the outer and inner ball tracks, the balls respectively define an outer and an inner contact curve, wherein the outer and inner ball tracks are configured such that the outer and inner contact curves are of equal length. In this way it is achieved in an advantageous way that the positions of the changes in gradient in the inner tracks and the outer tracks are reached simultaneously, when the balls roll on their respective contact curve in the respective track upon relative rotation of one ring relative to the other ring. In geometric terms this means that the conditions of the rotational angles of the inner and outer tracks are calculated according to the translation of a planetary drive with the respective parameters of ball radius, contact radius of the outer track, and contact radius of the inner track. To the extent that the balls in a longitudinal section comprise planar contact areas with the respective supporting face, wide contact curves are accordingly formed.

At least one group of the outer ball tracks and inner ball tracks, i.e., the outer and/or the inner ball tracks comprise an axial gradient component. By “axial gradient” it is meant that at least a partial portion of the ball tracks respectively enclose a gradient angle unequal to zero with a radial plane extending perpendicularly to the rotational axis. As a result of the axial gradient, a relative axial movement of one ring relative to the other ring is generated when the one ring rotates relative to the other ring.

According to an embodiment, the outer ball tracks and/or the inner ball tracks can comprise grooves in each of which a ball is guided. Alternatively or in addition, the outer ball tracks and/or the inner ball tracks can also comprise a circumferentially extending web which forms a lateral contact face for the balls. Needless to say, combinations of said embodiments are also possible, i.e., one of the rings comprises grooves whereas the other one of the rings comprises circumferentially extending webs.

In an embodiment, the outer ring and/or the inner ring are/is provided with at least three ramp-shaped circumferentially distributed ball tracks on each of which a ball is axially and radially supported. This results in good relative guiding conditions between the outer ring and the inner ring. The at least three ball tracks extend along less then 120° around the rotational axis. However, it is also possible to provide more than three ball tracks such as four, five or more. With an increasing number of balls and, accordingly, with an increasing number of ball tracks, the individual surface load decreases. The circumferential extension of the individual ball tracks is also shortened.

The drive unit is configured for rotatingly driving one of the two rings, so that one ring rotates relative to the other one of the two rings. The assignment as to which of the two rings, the outer ring or the inner ring is driven by the driving unit is freely selectable and can be configured according to the technical requirements and the space conditions, respectively. The assignment of the two rings in respect of axial support is also freely selectable, i.e. either the outer ring is axially supported and the inner ring is axially movable or vice versa. Overall, there exist the following possibilities: the outer ring is rotatingly drivable and axially supported and the inner ring is rotationally fixed and axially movable; the outer ring is held so as to be rotationally fixed and axially supported, and the inner ring is rotatingly drivable and axially movable; the outer ring is rotatingly drivable and axially movable, and the inner ring is rotationally fixed and axially movable; as well as the outer ring is held so as to be rotationally fixed and axially movable, and the inner ring is rotatingly drivable and axially supported. According to an embodiment it is proposed that the outer ring is axially supported against a stationary component and is rotatingly drivable by the drive unit, and that the inner ring is axially movable relative to the outer ring and is held in a rotationally fixed way relative to the stationary component. The stationary component can be a housing of a drive unit for example, in particular of a clutch assembly or a drive assembly.

According to an embodiment, at least one of the rings, i.e., the outer ring and/or the inner ring, are configured so as to be undercut-free in the axial direction. An axially undercut-free contour means that the production of the respective ring can be easy and cost-effective by using a forming process, for example, a pressing, stamping or sintering process.

According to an embodiment, the outer ball tracks and/or the inner ball tracks are configured such that an end position is defined in which the outer ring and the inner ring axially approach one another, i.e., are moved into one another, and a second end position in which the outer ring and the inner ring are arranged so as to be further apart from one another, i.e., moved out of one another. At least one of the two end positions, i.e., the first end position and/or the second end position can be achieved by suitably configuring the ball track contour of the outer and/or inner supporting face, for instance by an engagement contour in which the associated ball assumes a defined position.

The contours of the outer ball tracks and of the inner ball tracks, in the region which is reached by operating the drive unit, can comprise a rising run-out. The rising run-out, to a limited ascent, permits a further rotation of the rings relative to one another beyond the end position, so that the entire rotating mass of the drive unit is spring-suspended when swinging across the end position.

In particular, the outer ball tracks and/or the inner ball tracks can be configured such that along the relative path of rotation between the first end position and the second end position there is provided an intermediate engagement position. This engagement position makes it possible that the two rings are held at a defined distance relative to one another, which distance is arranged between the fully moved-in position and the fully moved-out position. In particular, this applies to conditions when the drive unit is deactivated. In an embodiment, the outer ball tracks and/or the inner ball tracks comprise a first portion with a first gradient and a second portion with a second gradient, wherein it is proposed in particular that between the first portion and the second portion a stepped intermediate portion is formed which defines the engagement position. In principle, the gradients of the first portion and of the second portion are freely selectable and can be configured according to technical requirements. In particular, the gradient of the first portion can be smaller, greater or equal to the gradient of the second portion. It is also possible that at least one of the first portion and the second portion, i.e., the first and/or the second portion, comprises a variable gradient around the circumference.

According to an embodiment, a cage can be provided with circumferentially distributed openings in which the balls are held. The cage wall regions can be configured so as to prevent the balls from falling out. For this, the axially opposed wall regions of the openings can each comprise a radially extending projection. The cage can be undercut-free in the axial direction, which means that the cage can be produced in one single pressing process in a two-part tool, wherein the tool parts are undercut-free in accordance with the contour of the cage.

According to an embodiment, the power transmitting device comprises a drive part which, for torque transmitting purposes, is in meshing engagement with an outer toothing at the rotatingly drivable ring. The rotatingly drivable ring can be the outer ring or the inner ring. The rotational axis of the drive part can be arranged in particular parallel to the rotational axis of the drivable ring. The drive part of the power transmitting device can be, for instance, a pinion, gearwheel, friction roller, toothed rack, toothed belt, V-belt or flat belt. Due to the transmission of power by the drive part radial forces act on the drivable ring. In case the driven ring is the outer ring, said radial forces—due to the two rings being arranged inside one another—can in an advantageous way be radially supported against the inner ring.

At least one spring element is provided which acts against the axial direction of movement generated by the drive part. In this context, the spring element can also be referred to as returning spring. A first end of the spring element can be axially supported against the second clutch part. The second end of the spring element can be axially supported against a driveshaft to which the second clutch part is connected in a rotationally fixed and axially movable manner. The driveshaft can be rotatably and axially supported in a stationary housing. The at least one spring element can be provided in the form of a helical spring for example, and it is to be understood that any other spring means for storing potential energy can also be used, for example at least one wave spring or plate spring.

A torque introduced by the drive unit into the driven ring causes the ball ramp unit to be moved apart against the force of the spring element which stores potential energy. In other words, when the drive unit is operated, the axially movable ring is moved into a first axial direction, whereas the spring means load the axially movable ring the opposed second axial direction.

According to an embodiment, one or more pretensioning springs can be provided which act in the same direction as the spring element. The at least one pretensioning spring is arranged such that the outer ring and the inner ring are pretensioned relative to one another, so that the balls are always held in surface contact with the outer and inner ball tracks to achieve a rolling movement. Thus, the positions of the balls are always defined even if the spring force of the returning spring is not supported via the balls, but for instance via contacting teeth of the form-locking clutch. The at least one pretensioning spring can have any configuration, for example it can be a wire spring, a sheet metal spring, a helical spring, a plate spring and/or a spring disc with resilient shackles.

According to a first configuration, the clutch can be provided in the form of a form-locking clutch. This refers to clutches, wherein a transmission of torque is effected by means of form-locking engagement of at least two clutch parts. This means that, for transmitting torque, the first clutch part and the second clutch part can be form-lockingly coupled to one another by inter-engaging form-locking elements. Examples for form-locking clutches are claw clutches, sliding-muff clutches or toothed clutches. By closing the clutch it is ensured that an input part connected to the first clutch part and an output part connected to the second clutch part rotate jointly, whereas in the open condition they are freely rotatable relative to one another.

According to a second configuration, the clutch can be provided in the form of a friction clutch which, for transmitting torque comprises at least one pair of friction faces effective between the first and the second clutch part. As an example of a friction clutch, a multi-plate friction clutch comprises first friction plates connected to the first clutch part in a rotationally fixed and axially movable way and second friction plates connected to the second clutch part in a rotationally fixed and axially movable way. By axially loading the plate package formed of the first and second friction plates, the rotational movement between the two clutch parts is adjusted. A friction clutch makes it possible that the transmittable torque can be variably set according to existing requirements, because also any immediate positions between the closed position in which the two clutch parts rotate jointly and the open position in which the two clutch parts rotate freely relative to one another can be set.

It applies to both configurations that the clutch is generally loaded in the closed condition and that the clutch is disconnected as a result of an external operation. To that extent the clutch can also be referred to as a disconnect clutch. Furthermore, it is proposed that the axially movable ring of the ball ramp assembly is effectively connected with the clutch such that the clutch is opened when the drive unit is operated. According to an embodiment, the first clutch part can be supported in a housing so as to be rotatable around the rotational axis, with the second clutch part being axially movable, wherein the axially movable ring is loaded by the returning spring in the first direction in which the first clutch part and the second clutch part engage one another for transmitting torque; and wherein the axially movable ring, upon operation of the drive unit, is axially loaded in the second direction in which the first clutch part and the second clutch part are disengaged.

According to a further embodiment a brake unit can be provided for braking a driveline portion which is connected to the first or the second clutch part. The brake unit is preferably operated by the ball ramp assembly, in particular by the second gradient portions of the outer ring and the inner ring respectively. The brake unit can comprise a brake part which is firmly connected to the movable clutch part and a second brake part connected to the second brake part. The two brake parts are brought into friction contact by moving apart the ball ramp unit, and optionally one or several friction plates can be arranged between the brake parts. As a result of friction contact between the brake parts, the axially movable clutch part is delayed until it stands still. This means that all the driveline parts drivingly connected to the clutch part stand still.

A method of controlling the clutch assembly can comprise the following steps: opening the form-locking clutch by operating the drive unit into a first operating direction, wherein the axially movable ring is moved at least into the intermediate engagement position; braking the driveshaft which is connected to the second clutch part when the first clutch part and the second clutch part are disengaged by moving the axially movable ring beyond the intermediate engagement position away from the axially supported ring; deactivating the drive unit, with the axially movable ring being held in the intermediate engagement position at a distance relative to the axially supported ring, so that the form-locking clutch remains open; closing the form-locking clutch by operating the drive unit into an opposed second operating direction, wherein the axially movable ring is moved out of the intermediate engagement position and is loaded towards the axially supported ring by the returning spring.

The described clutch assembly with the ball ramp unit, when being operated, generates only low friction forces and comprises a low hysteresis. As a result, the clutch assembly is very easy to control by a relatively small electric motor which requires only a low driving torque for providing comparable axial forces. Said compact system having only one single set of rolling members can replace a merely axially arranged rolling contact member ball ramp device combined with an additional roller bearing for radially rollingly supporting the tooth forces of the geared drive of the electric motor. Overall, a compact, structurally simple, and thus cost-effective, configuration is thus achieved.

Said clutch assembly can be used in particular in the driveline of a motor vehicle for interrupting a transmission of torque to the optionally drivable driving axis, when required (“disconnect” principle). According to an embodiment, the clutch assembly can be integrated into a power take-off unit (PTU) or a transfer case. In particular, a power take-off unit comprises an input shaft, a ring gear, a pinion engaging the ring gear and an output shaft, wherein it is proposed in particular that the clutch assembly is arranged in the power path between the input shaft and the ring gear. According to such a power take-off unit the above-mentioned advantages of a simple operation of the clutch are achieved while keeping the operating and holding forces low. It is to be understood that the clutch assembly can also be arranged in another location in the driveline of the motor vehicle, for example in a differential gearing.

### SUMMARY OF THE DRAWINGS

Exemplary embodiments will be explained below with reference to the Figures, wherein

FIG. 1 shows an example clutch assembly in a first embodiment in a perspective exploded view.

FIG. 2 shows the example clutch assembly in a perspective sectional view.

FIG. 3 shows the clutch assembly according to FIG. 1 in a longitudinal section in the closed position.

FIG. 4 shows the clutch assembly according to FIG. 1 in a longitudinal section in the open position.

FIG. 5 shows the clutch assembly according to FIG. 1 in a longitudinal section in braking position.

FIG. 6 shows the clutch assembly according to FIG. 1 in a longitudinal section in the closed position with further details.

FIG. 7 shows the clutch assembly according to FIG. 1 in a radial view in the closed position.

FIG. 8 shows the ball ramp unit of the clutch assembly according to FIG. 1 in perspective exploded view.

FIG. 9 shows the ball ramp unit of the clutch assembly according to FIG. 1 in a longitudinal section.

FIG. 10 shows the outer ring of the ball ramp unit according to FIG. 8 in a longitudinal section.

FIG. 11 shows the ball cage of the ball ramp unit according to FIG. 8 in a longitudinal section.

FIG. 12 shows the inner ring of the ball ramp unit according to FIG. 8 in a longitudinal section.

FIG. 13 shows an example clutch assembly in a second embodiment in a longitudinal section.

FIG. 14 shows an example clutch assembly in a third embodiment in a longitudinal section.

### DETAILED DESCRIPTION

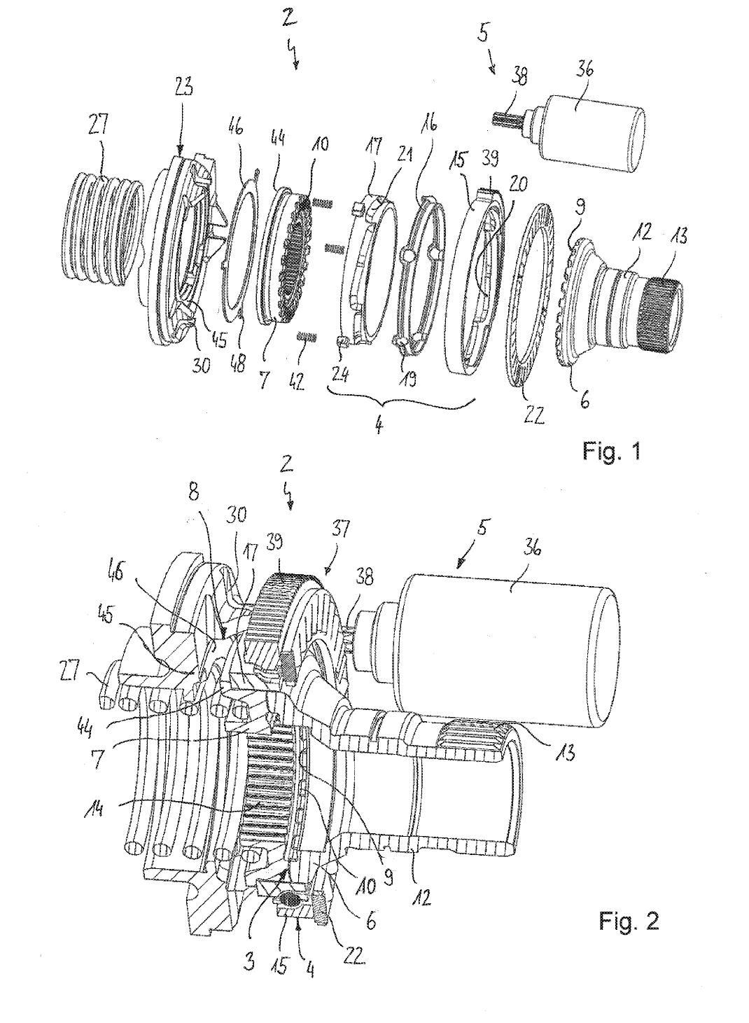

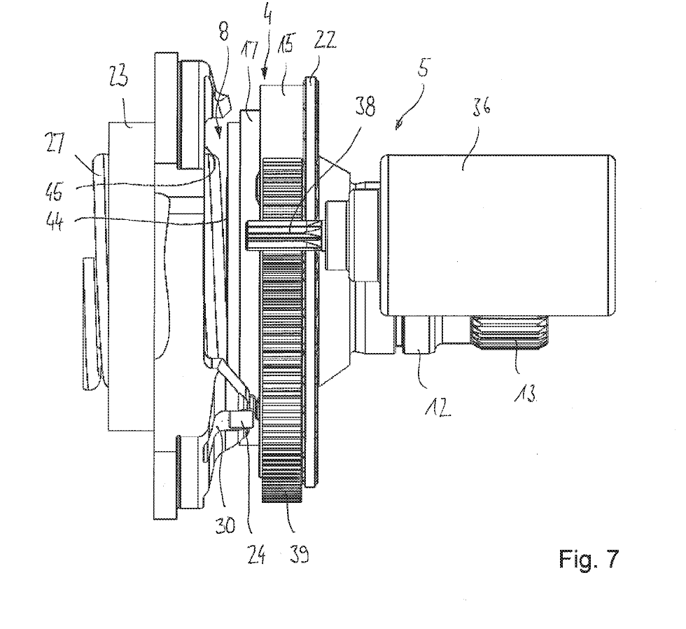

FIGS. 1 to 12 will be described jointly below. They show a clutch assembly 2 having a clutch 3, a ball ramp unit 4 for operating the clutch 3, and a drive unit 5 for operating the ball ramp unit 4. The clutch 3 comprises a first clutch part 6 and a second clutch part 7, which are arranged so as to be rotatable relative to each other around a rotational axis A, and which can be transferred at least into a closed position and an open position.

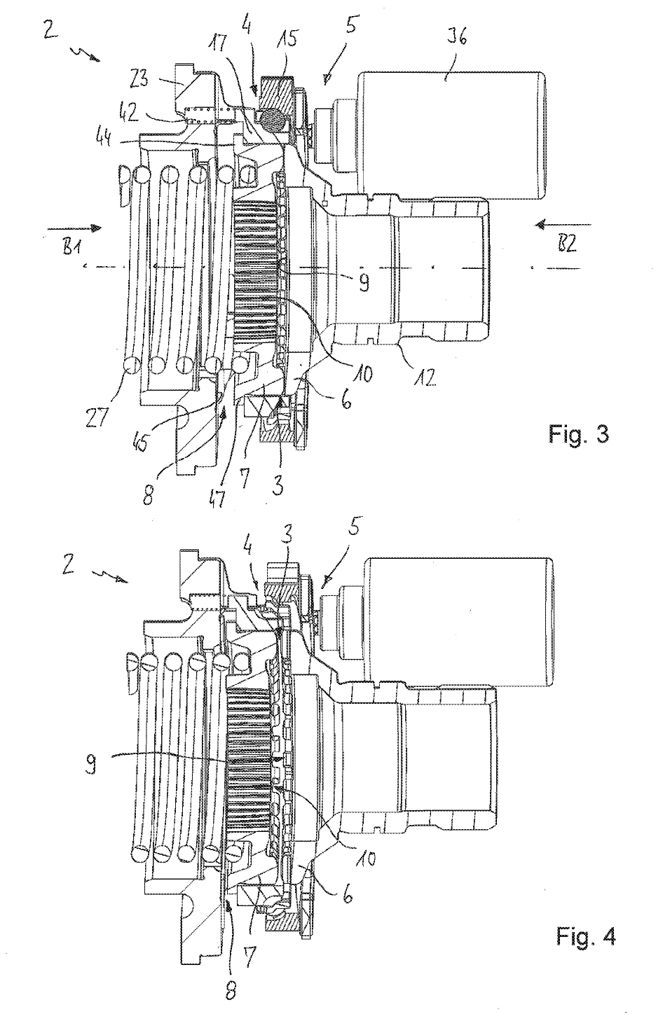

The clutch 3 is provided in the form of a force-locking clutch, wherein the first clutch part 6, on an end face, comprises a first engagement profile 9 which, in the closed position of the clutch 3, engages a corresponding second engagement profile 10 of the second clutch part 6 for transmitting torque. The engagement profiles 9, 10 of the first and the second clutch part 6, 7 are provided in the form of respective face toothings. FIG. 3 shows the clutch 3 in a closed position in which the second clutch part 7 approaches the first clutch part 6, so that the engagement profiles of the clutch parts engage one another for torque transmitting purposes. In FIG. 4, the second clutch part 7 is moved into the second axial direction B2 and is in the open position in which tooth engagement between the two clutch parts 6, 7 is interrupted. In this position, the second clutch part 7 is axially displaced relative to the first clutch part 6, so that the clutch parts 6, 7 rotate freely relative to one another, i.e., a transmission of torque is interrupted.

The first clutch part 6 is configured so as to be integral with a driveshaft 12 which comprises shaft splines 13 for introducing torque. The second clutch part 7 is configured so as to be ring- or sleeve-shaped and comprises inner shaft splines 14 which can be engaged by an attaching part for transmitting torque. However, it is to be understood that the first clutch part 6 and the second clutch part 7 can also comprise a different configuration according to the technical requirements of the attaching parts and, in particular, they can also comprise different attaching means for transmitting torque.

The ball ramp unit 4 comprises an outer ring 15 with a plurality of circumferentially distributed, ramp-shaped outer ball tracks 20, an inner ring 17 with a plurality of circumferentially distributed, ramp-shaped inner ball tracks 21, a ball cage 16, as well as a plurality of balls 19. The balls 19 are each arranged and guided in a pair of tracks consisting of an outer ball track 20 and an inner ball track 21. The outer and inner ball tracks 20, 21 substantially extend in the circumferential direction and comprise at least one portion having an axial gradient component. Due to the axial gradient, the balls 19 roll in the ball tracks 20, 21 when the outer ring rotates relative to the inner ring 17, so that the inner ring 17 is axially moved relative to the outer ring 15.

The balls 19 are held in the cage 16 having circumferentially distributed openings 18 in defined circumferential positions. As can be seen in particular in FIG. 11, the wall regions surrounding the openings 18 are configured such that the balls 19 are prevented from falling out. For this purpose, the axially opposed wall regions of the openings each comprise a projection adapted to the ball contour, so that the balls are radially and axially held between the projections. Furthermore, it is proposed that the cage 16 is configured to be undercut-free in the axial direction. As a result, the cage can be produced in one single pressing process by means of a simple forming operation.

In the present embodiment, the outer ring 15 is rotatably and axially supported by an axial bearing 22 relative to a stationary component 35, as can be seen in particular in FIG. 6. However, it is to be understood that different configurations in respect of which ring is axially supported and which ring is axially movable are also possible, which also applies as to which ring is rotatingly drivable and which ring is held so as to be rotationally fixed.

The inner ring 17 is loaded by spring means 27 in the direction towards the outer ring 15, which direction can also be referred to as the first direction B1 and which corresponds to the closed position of the clutch 3. The spring means 27 act against the axial setting direction of the drive unit 5 and to that extent they can be referred to as returning springs. In principle the spring means 27 can have any configuration, which includes in particular the possibility of providing one or more springs. In the present embodiment, the spring means comprise a helical spring which is arranged coaxially relative to the rotational axis A. A first end of the helical spring is axially supported at the driveshaft (not illustrated) which, via the inner splines 14, is connected to the second clutch part 7 in a rotationally fixed way. A second end of the helical spring 27 is axially supported on a supporting portion 28 of the second clutch part 7. Specifically, the second clutch part 7, on a side facing away from the first clutch part, comprises an annular chamber 29 into which the second end of the helical spring 27 extends into.

The outer ring 15 comprises an inner face 25 into which the ball tracks 20 are incorporated. The inner ring 17 comprises an outer face 26 which comprises a radial play opposite the inner face 25 of the outer ring 15. The inner ring 17 is arranged coaxially relative to the outer ring 15, and relative to the rotational axis A, and guided in an axially movable way. The opposed faces 25, 26 of the outer ring 15 and of the inner ring 17 overlap at least partially in the axial direction, i.e., the inner ring 17 at least partially axially extends into the outer ring 15. The outer ball tracks 20 comprise a greater mean diameter than the inner ball tracks 21. A smallest inner diameter of the outer ball tracks 20 is greater than a greatest outer diameter of the inner ball tracks 12.

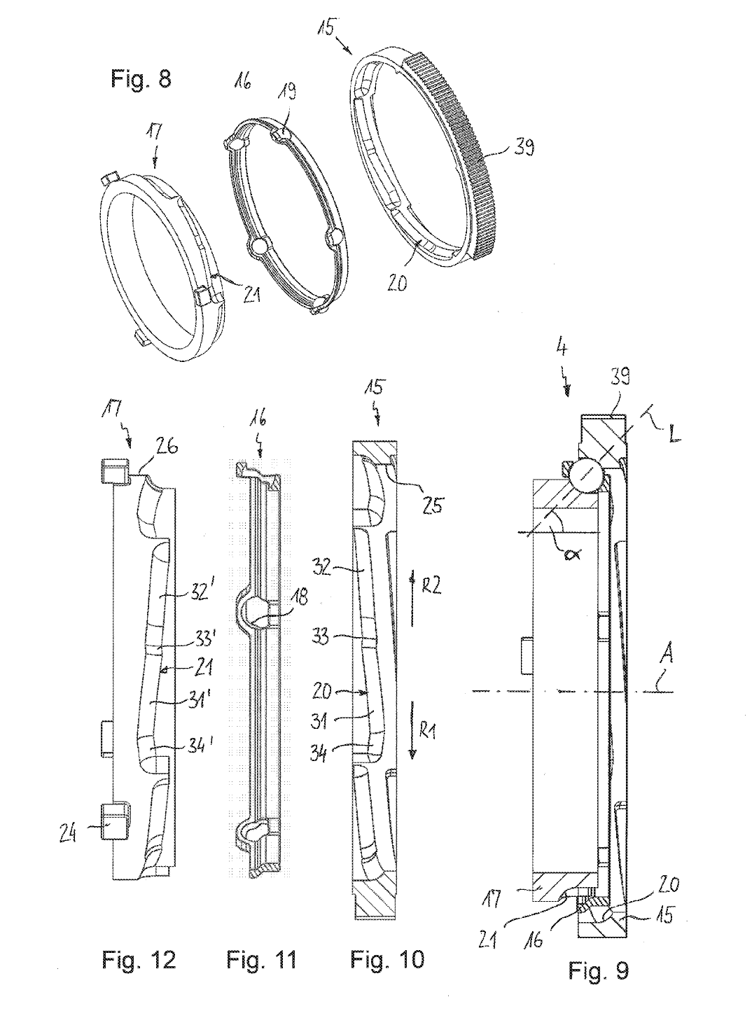

It is proposed that the outer ball tracks 20 and the inner ball tracks 21 extend in the circumferential direction across less than 120°. As can be seen in particular in FIG. 8, in the present embodiment the outer ring 15 and the inner ring 17 each contain five ball tracks 20, 21 which extend along a circumferential direction of less than 90° and more than 60°. The outer and inner ball tracks 20, 21 are configured such that a force line L which, in a longitudinal section extends through an outer and inner ball contact region, encloses an angle α with the rotational axis A, which is greater than 0° and smaller than 90°. In this way, the ball ramp device 4, if viewed in the longitudinal section, is configured as a type of an angular contact ball bearing, so that, in addition to the axial support, there is also achieved a particularly good radial support of the outer ring relative to the inner ring. Thus, any radial forces introduced by the drive unit 5 into the outer ring during the transmission of torque can be supported particularly well.

The ball tracks 20, 21 each comprise a variable depth along the circumference, which can be seen in particular in FIGS. 8, 10, and 12. In particular, the outer ball tracks 20 and the inner ball tracks 21 can be configured to correspond to one another, i.e., the contours of an outer ball track 20 and of an associated inner ball track 21 which together accommodate a ball 19, correspond to one another at least substantially. When the balls 19 roll along the outer and inner ball tracks 20, 21, the balls 19 define an outer and inner contact curve. To ensure that the end positions and intermediate positions of the two rings 15, 17, are synchronously reached, the outer and inner ball tracks 20, 21 are configured such that the outer and inner contact curves are of equal length. The outer and the inner ball tracks 20, 21 are respectively configured such that a first end position is defined in which the outer ring 15 and the inner ring 17 are completely moved into one another and comprise a shortest axial distance relative to one another, as well as a second end position in which the outer ring and the inner 17 are fully extracted from one another and comprise a greatest axial distance from one another.

Starting from the deepest point which defines the first end position, the outer and inner ball tracks 20, 21 comprise a first portion 31, 31′ with a first gradient as well as a second portion 32, 32′ with a second gradient. The gradient of the second portion 31 is slightly smaller than the gradient of the first portion 31, wherein it is to be understood that the gradients depend on the technical requirements and can also be configured to be different. Between the first portion 31, 31′ and the second portion 32, 32′ an intermediate portion 33, 33′ is provided which defines an engagement position. In the engagement position, i.e. when the balls 19 are positioned in the opposed intermediate portions 33, 33′, the two rings 15, 17 are held at a defined axial distance relative to one another. Said embodiment with engaging intermediate portions 33, 33′ makes it possible for the clutch 3 to assume an intermediate position between the fully closed position and the fully open position at a defined axial distance. The contour of the intermediate portion 33, 33′ is configured to be such that the two rings 15, 17 are held self-contained in the intermediate position, even if the drive unit 5 is deactivated and in spite of the inner ring 17 being force-loaded by the spring 27.

Furthermore, it can be seen that the outer and inner ball tracks 20, 21 in the region of the first end position, i.e. in the approached position, comprise a rising run-out 34, 34′. The rising run-out 34, 34′ achieves a further rotation of the rings 15, 17 relative to one another beyond the end position to a limited extent, so that the entire rotating mass of the drive unit is spring-suspended when it overshoots beyond the end position. The gradient and the circumferential length of the run-out 34, 34′ are configured to be such that the clutch 3 remains in the closed position even if the balls run into this region and if the two rings 15, 17 again slightly move away from one another.

The drive unit 5 provided for operating the ball ramp unit 4 is configured to rotatingly drive one of the two rings 15, 17 so that this ring is rotated relative to the other one of the two rings 17, 15. Specifically in the present embodiment the outer ring 15 is rotatingly driven by the drive unit 5, whereas the inner ring 17 is held in a rotationally fixed and axially displaceable manner relative to a stationary housing part 23. For this purpose, the inner ring 17 comprises a plurality of circumferentially distributed radial projections 24 which engage corresponding longitudinal grooves 30 of the housing part 23, so that the inner ring 17 is held in a rotationally fixed, but axially movable way in the housing part 23.

It is proposed that the drive unit 5 comprises a controllable driving source 36 and a force transmitting device 37 for transmitting a force to the ball ramp unit 4, which force is generated by the driving source 36. The driving source 36 is provided in the form of an electric motor, in particular in the form of a DC motor. The electric motor is controllable be an electronic control unit (ECU) (not illustrated).

The force transmitting device 37 comprises a drive part 38 which, in the present embodiment, is configured as a driving pinion and is in meshing engagement with an outer toothing 39 of the outer ring 15 for transmitting torque. Driving the outer ring 15 generates a relative rotation relative to the inner ring 17 held in a rotationally fixed way, so that the balls 19 move along the ball tracks 20, 21 into deeper regions, with the inner ring 17 being axially moved in the direction B2 towards the second clutch part 7. Because of the transmission of power from the drive part 38 to the outer ring 15, radial forces act accordingly on the latter. Because of the interleaved arrangement of the ball ramp unit 4, the radial forces can be supported particularly effectively.

As already mentioned above, for opening the clutch 3 the drive unit 5 acts in the opposite direction of the spring 27 which axially loads the two clutch parts 6, 7 in the engaged position. The inner ring 17 comprises a supporting face 40 against which the second clutch part 7 is axially supported with a contact face 41. For this purpose, the second clutch part comprises a collar or radial projection 47 against which the inner ring 17 is axially supported. Starting from the closed position of the clutch 3, the inner ring 17 is moved axially away from the outer ring 15 by operating the drive unit 5. Accordingly, the inner ring 17 loads the second clutch part against the pretensioning force of the clutch spring 27 away from the first clutch part 6, so that the clutch 3 is opened. The clutch 3 is closed again by deactivating the drive unit 5 and/or by at least briefly operating the drive unit 5 in the opposite direction out of the intermediate position. Thereby, the clutch 3 is closed by the clutch spring 27 which again loads the second clutch part 7 towards the first clutch part 6.

A plurality of pretensioning springs 42 is provided which axially load the inner ring 17 towards the outer ring 15. The pretensioning springs 42 ensure that the two rings 15, 17 are always slightly pretensioned relative to one another so that the balls 19, with a rolling movement, are always in contact with the outer and inner ball tracks 20, 21. In particular, this applies in cases where the two clutch parts 6, 7—when closing the clutch 3—are in a rotational position in which two teeth are positioned opposite one another, i.e. if there exists a tooth-on-tooth position instead of a tooth-gap position. In said tooth-on-tooth position, the clutch is still partially open. In order that in said clutch position the ball ramp unit 4 can also operate effectively by a rolling contact of the balls, the pretensioning springs 42 load the ball ramp unit in the closing sense. In the present embodiment, the pretensioning springs 42 are provided in the form of helical spring which are positioned in circumferentially distributed bores 43 of the housing part 23. In fact, there are provided three bores 43 and three pretensioning springs 42 accordingly which are arranged in the region of the circumferentially distributed grooves 30 of the housing part 23. Equally, this function can be taken over by other types of spring such as a wire spring, a sheet metal spring, a plate spring, an ondular spring and/or a spring disc with resilient shackles.

In addition to the function of coupling and uncoupling a driveline by the clutch 3, the present clutch assembly 2 can comprise a further function, i.e., braking a driveline portion connected to the second clutch part 7. For this, a brake unit 8 is provided having a first brake part 44 that is fixed to the second clutch, as well as a second brake part 45 which is fixed to a stationary housing. By axially loading the second clutch part 7 away from the first clutch part 6, the brake part 44 connected to the second clutch part 7 and rotating jointly with same is loaded against the stationary brake part 45. As a result of the friction-locking action between the brake parts 44, 45, the first brake part 44 is delayed until it stops. Thus, all the driveline parts which are drivingly connected to the brake part 44 stand still. In the present embodiment, the friction-locking effect between the two brake parts 44, 45 is achieved indirectly via an intermediate friction disc 46. The friction disc comprises a plurality of circumferentially distributed projections 48 which engage the grooves 30 of the stationary housing part 23, so that the friction disc 46 is held in a rotationally fixed and axially movable way.

The first brake part 44 is produced so as to be integral with the second clutch part 8 and, in particular, constitutes part of the annular portion of the clutch part 8. The second brake part 45, in particular, is produced so as to be integral with the housing 23. When the brake 8 is closed, the clutch 3 is open, so that the driveline section drivingly connected to the second clutch part 7 is uncoupled from the first clutch part 6. In the closed condition of the clutch 3, the brake 8 is released, so that the second clutch part 7 and all the components drivingly connected thereto can rotate freely. The brake 8 is operated by the drive unit 5. Below, the various operating modes are described.

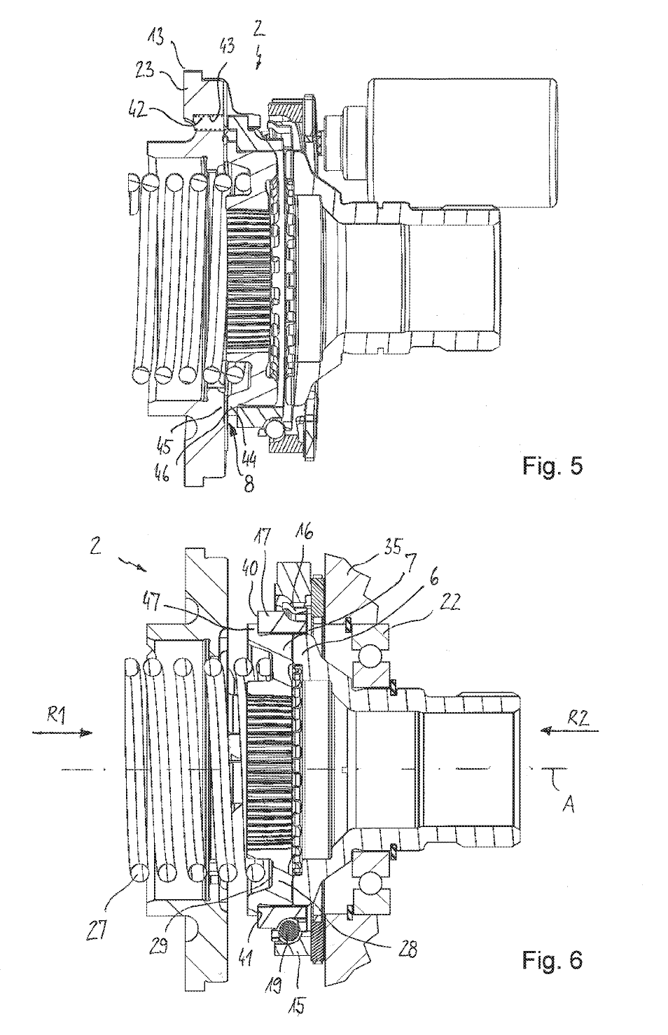

Each setting contour of the outer ring 15 is associated with a setting contour of the inner ring 17. In the first end position of the drive unit 5, the balls 19 are in the deepest position of the first portion 31, 31′ of the setting contour and the ball track 20 respectively, so that the two rings 15, 19 axially approach one another. In this switched condition, which is shown in FIGS. 2, 3, and 6, the clutch 3 is closed (in the connect mode). By relatively rotating the outer ring 17 in the first rotational direction R1, the balls 19 move along the gradient portion 31, so that the inner ring 17 is axially loaded away the outer ring 15. In the process, the second clutch part 7 on which the inner ring 17 is axially supported is loaded away from the first clutch part 6, so that the clutch 3 is opened. A completely open condition is achieved when the balls 19 each have reached the intermediate portions 33, 33′. This condition is shown in FIG. 4. It can be seen that the clutch 3 and the brake 8 are open. This condition can also be referred to as freewheeling (disconnect mode). By continuing to rotate the outer ring 15 in the first rotational direction R1 beyond the freewheeling condition, the inner ring 17 together with the second clutch part 7 and the first brake part 44 are loaded towards the second brake part 45 (B2). This is achieved in that the balls 19 roll along in the second gradient portions 32, 32′. Thereby, the two brake parts 44, 45 come into frictional contact with each other, so that the rotating brake part 44 together with said drivingly connected components are braked relative to the stationary housing 23. This brake mode is shown in FIG. 5. In this mode, the driveshaft (not shown) connected to the second clutch part 7 stands still and does not transmit any torque. By configuring the ramp assembly in this form it is ensured that the brake 8 is not closed until the clutch 3 is fully open.

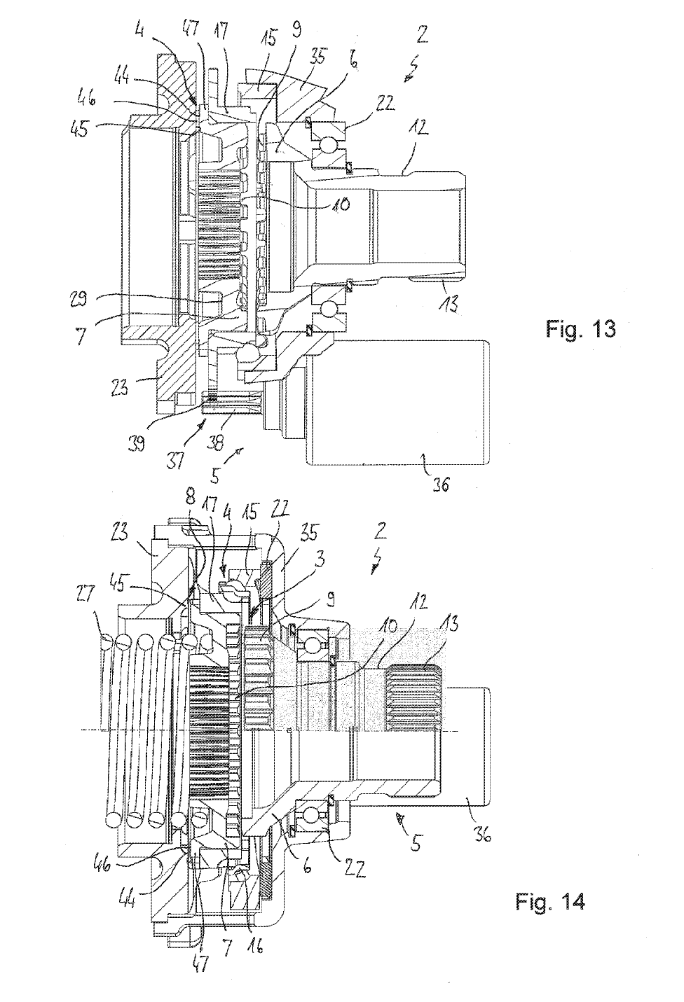

FIG. 13 shows an example clutch assembly 2 in a second embodiment which largely corresponds to the embodiment according to FIGS. 1 to 12 to the description of which reference is hereby made. Identical details and/or details corresponding to one another have been given the same reference numbers as in FIGS. 1 to 12. To avoid any repetition, reference is made in particular to the differences of the present embodiment.

In the present embodiment according to FIG. 13, the outer ring 15 is held in a rotationally fixed way, whereas the inner ring 17 is rotatingly drivable by the drive unit 5. Specifically the outer ring 17 is fixed in a stationary housing part 35, namely in a rotational fixed, axially fixed and radially fixed way. Fixing can be achieved by pressing the outer ring 15 in a corresponding recess of the housing part 35. The inner ring 17 is rotatably supported on the second clutch part 7 by a sliding bearing. At its outer circumferential face, the inner ring 17 comprises a tooth segment 39 which engages the drive pinion 38. By operating the driving source 36, the inner ring 17 is rotated relative to the outer ring 15, so that the clutch 3 is opened. The present embodiment of the clutch assembly 2 is shown in the braked mode, i.e., it is shown with the clutch 3 being completely open and with the second clutch part 7 being braked. Otherwise, the present embodiment, in respect of configuration and mode of functioning, corresponds to that according to FIGS. 1 to 12, so that, to avoid any repetition reference is made to the above description.

FIG. 14 show an example clutch assembly 2 in a third embodiment which largely corresponds to that according to FIGS. 1 to 12 to the description of which reference is hereby made. Identical details and details corresponding to one another respectively have been given the same reference numbers as in FIGS. 1 to 12. To avoid any repetition, in particular, reference is made to the differences of the present embodiment.

A difference of the present embodiment according to FIG. 14 lies in the configuration of the clutch 3 which, in the present embodiment is shown as a toothed clutch. For this, the first clutch part 6 comprises outer teeth 9 which can engage corresponding inner teeth 10 of the second clutch part 7. Otherwise, the present embodiment, in respect of configuration and functioning, corresponds to that according to FIGS. 1 to 12, so that to avoid any repetition, reference is made to the above description.

### LIST OF REFERENCE NUMBERS

2 clutch assembly
3 clutch
4 ball ramp unit
5 drive unit
6 first clutch part
7 second clutch part
8 brake unit
9 engagement profile
10 engagement profile
11
12 driveshaft
13 shaft splines
14 shaft splines
15 outer ring
16 cage
17 inner ring
18 opening
19 ball
20 ball track
21 ball track
22 axial bearing
23 stationary housing part
24 projection
25 inner face
26 outer face
27 spring means
28 supporting portion
29 annular chamber
30 groove
31 first portion
32 second portion
33 intermediate portion
34 run-out
35 stationary component
36 driving source
37 force transmitting device
38 output part
39 outer teeth
40 supporting face
41 contact face
42 pretensioning spring
43 bore
44 first brake part
45 second brake part
46 friction disc
47 collar
48 projection
A rotational axis
B axial direction
L force line
R rotational direction
α angle

1.-16. (canceled)

17. A clutch assembly for a driveline of a motor vehicle, comprising:
a disconnect clutch for disconnecting a driveline, wherein the disconnect clutch comprises at least a first clutch part and a second clutch part;
a spring element that loads the disconnect clutch into a closed position in which the torque is transmittable between the first clutch part and the second clutch part;
a ball ramp unit for loading the disconnect clutch into an open position, wherein the ball ramp unit comprises an outer ring with a plurality of circumferentially distributed outer ball tracks, an inner ring with a plurality of circumferentially distributed inner ball tracks, and a plurality of balls which are each arranged between an outer ball track and an inner ball track;
a drive unit for operating the ball ramp unit, wherein the drive unit is configured to rotatingly drive one of the outer ring and the inner ring around a rotational axis; wherein the outer ball tracks and the inner ball tracks are configured to be ramp-like such that rotatingly driving the rotatingly drivable ring by the drive unit effects a relative axial movement between the outer ring and the inner ring, so that the disconnect clutch is opened;
wherein the outer ball tracks and the inner ball tracks extend in the circumferential direction across less than 120°, and wherein the outer ball tracks and the inner ball tracks are configured such that a force line, that in a longitudinal section extends through an outer and an inner ball contact area, encloses an angle with the rotational axis that is greater than 0° and smaller than 90°.

18. The clutch assembly according to claim 17,
wherein the outer ball tracks and the inner ball tracks are configured such that the angle which is enclosed by the force line and the rotational axis is greater than 20° and smaller than 70°.

19. The clutch assembly according to claim 17,
wherein the inner ring is configured sleeve-like and extends into the outer ring, so that the inner ring and the outer ring at least partially axially overlap.

20. The clutch assembly according to claim 17,
wherein at least one of the outer ball tracks and the inner ball tracks are configured such that a first end position is defined in which the outer ring and the inner ring are axially approximated to one another, wherein the disconnect clutch is in the closed position,
and wherein in a second end position in which the outer ring and the inner ring are arranged so as to be further away from one other, wherein the disconnect clutch is in the open position.

21. The clutch assembly according to claim 17,
wherein at least one of the outer ball tracks and the inner ball tracks are configured such that along the relative rotational path an engagement position is provided between the first end position and the second end position such that, in the engagement position, the outer ring and the inner ring are held at a defined axial distance from one another when the drive unit is deactivated.

22. The clutch assembly according to claim 17,
wherein at least one of the outer ball tracks and the inner ball tracks comprise a first portion with a first gradient and a second portion with a second gradient, wherein between the first portion and the second portion a deepened intermediate portion is formed which defines the engagement position.

23. The clutch assembly according to claim 17,
wherein at least one of the outer ring and of the inner ring is configured to be undercut-free in an axial direction.

24. The clutch assembly according to claim 17,
wherein a cage is provided with circumferential openings in which the balls are held, wherein wall regions of the cage surrounding the openings are configured such that the balls are prevented from falling out.

25. The clutch assembly according to claim 17,
wherein the balls when rolling along the outer and inner ball tracks each define an outer and inner contact line, wherein the outer and inner ball tracks are configured such that the outer and inner contact lines are of equal length.

26. The clutch assembly according to claim 17,
wherein the outer ring is axially supported against a stationary component and is rotatingly drivable by the drive unit, and
wherein the inner ring is axially movable relative to the outer ring and is held in a rotationally fixed manner relative to a housing.

27. The clutch assembly according to claim 17,
wherein the drive unit comprises a controllable driving source and a force transmitting device for transmitting a force generated by the driving source to the ball ramp unit,
wherein the force transmitting device comprises a drive part which meshingly engages an outer toothing at the outer ring for transmitting torque.

28. The clutch assembly according to claim 17,
wherein the spring is installed and configured such that it acts against an axial movement direction generated by the drive unit and loads the disconnect clutch into a closed position.

29. The clutch assembly according to claim 17,
wherein at least one pretensioning spring is provided which acts in the same direction as the spring and pretensions the outer ring and the inner ring relative to one another, so that the balls, to achieve a rolling movement, are always held in contact with the outer and inner ball tracks.

30. The clutch assembly according to claim 17,
wherein a braking device is provided for braking one of the first and the second clutch part, wherein the braking device is operable by the drive unit via the ball ramp assembly.

31. The clutch assembly according to claim 17,
wherein the disconnect clutch is configured in the form of a form-locking clutch, wherein, in the closed position, the first clutch part and the second clutch part engage one another in a form-fitting way and, in the open position, are disconnected from one another so that the first clutch part and the second clutch part are freely rotatable relative to one another;
wherein the ball ramp unit is effectively connected to one of the first and of the second clutch part such that, when the ball ramp unit is operated, the first and the second clutch part are moved away from one another by the drive unit.

32. A method of controlling a clutch assembly for a driveline of a motor vehicle that comprises:
a disconnect clutch for disconnecting a driveline, wherein the disconnect clutch comprises at least a first clutch part and a second clutch part;
a spring element that loads the disconnect clutch into a closed position in which the torque is transmittable between the first clutch part and the second clutch part;
a ball ramp unit for loading the disconnect clutch into an open position, wherein the ball ramp unit comprises an outer ring with a plurality of circumferentially distributed outer ball tracks, an inner ring with a plurality of circumferentially distributed inner ball tracks, and a plurality of balls which are each arranged between an outer ball track and an inner ball track;
a drive unit for operating the ball ramp unit, wherein the drive unit is configured to rotatingly drive one of the outer ring and the inner ring around a rotational axis; wherein the outer ball tracks and the inner ball tracks are configured to be ramp-like such that rotatingly driving the rotatingly drivable ring by the drive unit effects a relative axial movement between the outer ring and the inner ring, so that the disconnect clutch is opened;
wherein the outer ball tracks and the inner ball tracks extend in the circumferential direction across less than 120°, and wherein the outer ball tracks and the inner ball tracks are configured such that a force line, that in a longitudinal section extends through an outer and an inner ball contact area, encloses an angle with the rotational axis that is greater than 0° and smaller than 90°,
wherein one of the outer ring and the inner ring is axially supported on a stationary component and the other one of the outer ring and the inner ring is axially movable by operating the drive unit;
the method comprising:
opening the disconnect clutch by operating the drive unit in a first operating direction, wherein the axially movable ring is at least moved into an engagement position;
braking a driveshaft connected to the second clutch part when the first clutch part and the second clutch part are disconnected from one another by moving the axially movable ring beyond an engagement position away from the axially supported ring, so that the second clutch part is at least indirectly brought into contact with a stationary component;
deactivating the drive unit, wherein the axially movable ring is held in the engagement position at a distance from the axially supported ring, so that the disconnect clutch remains open; closing the disconnect clutch by operating the drive unit in an opposed second operating direction, wherein the axially movable ring is moved out of the intermediate engagement position and is loaded towards the axially supported ring by the spring.
